(19) United States
(12) Patent Application Publication
(10) Pub. No.: US 2003/0101252 A1
(43) Pub. Date: May 29, 2003

(54) System and method for supporting SNMP managed networks

(75) Inventor: Herbert Lyvrin Lacey III, Garner, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Globespan Virata Incorporated, Red Bank, NJ (US)

(21) Appl. No.: 10/065,347

(22) Filed: Oct. 7, 2002

Related U.S. Application Data
(60) Provisional application No. 60/327,401, filed on Oct. 5, 2001.

(51) Int. Cl. G06F 15/173; G06F 13/10

(52) U.S. Cl. 709/223; 709/321

(57) ABSTRACT

A system and method is provided for supporting partial management information base population in managed devices in a simple network management protocol system. A default, working copy of all local management information base information is stored within the agent as default management information base values. Upon request by network management system for management information base information from the device, an SNMP agent populates an management information base table with information provided by the managed device as well as information included in the default management information base table. Consequently, all local management information bases are always be fully populated.

### CROSS REFERENCE TO RELATED APPLICATIONS

This application claims the benefit of U.S. provisional patent Application No. 60/327,401 filed Oct. 5, 2001, the disclosure of which is incorporated herein by reference.

### BACKGROUND OF THE INVENTION

The present invention relates generally to communication systems and, in particular, to systems for managing devices which make up the communications systems. More particularly, the present invention relates to systems and methods for establishing and implementing a management protocol for governing the management of the communications system devices.

In their simplest form, all communications networks comprise a variety of individual network devices connected to at least one other such device. These devices then operate to transmit information to each other. As the size of networks has increased as well as the number of individual devices and device manufacturers which together make up the networks, there arose a need to enable management of the various devices from a location remote to the devices in question so as to facilitate uncongested, error-free transmissions. To this end, the Internet Architecture Board (“IAB”) in the late 1980's developed a set of tools, protocols, and a common database for general network management. Collectively, this standard was termed simple network management protocol (“SNMP”).

An SNMP managed network comprises three main elements to perform its management functions: at least one managed device; a network management system (“NMS”) for facilitating the various management functions, and at least one SNMP agent (“agent”) for providing the interface to the managed devices. Examples of managed devices include bridges, hubs, routers, servers, etc. which can collect and store management information regarding their operation. Typically, agents are software modules which perform their tasks by residing on the particular device to be managed. Each agent typically maintains a local database of variables that describe its state and history and affect its operation. In this system, the NMS is operated under the control of a network manager, who is responsible for detecting and correcting problems that make communication inefficient or impossible and to eliminate the conditions that will produce the problem again.

Specifically regarding the protocol itself, SNMP defines exactly how the NMS communicates with an agent. For example, SNMP defines the format of requests that the NMS sends to an agent and the format of that an agent returns. In addition, SNMP defines the exact meaning of each possible request and reply. SNMP further specifies that an SNMP message must be encoded using a standard known as Abstract Syntax Notation.1 (“ASN.1”). SNMP enables two general types of management operations: “get” operations whereby device status, history and other attribute values (collectively, referred to as “objects”) are retrieved from the managed device, and “set” operations whereby device objects are modified. According to standardized naming conventions, each object that can be retrieved or modified is given in a unique name. Correspondingly, any particular commands that specifies get or set operations must specify this unique object name. Typically, communications between the NMS and its agents use User Datagram Protocol (“UDP”) services on the network to exchange messages.

Regarding the information exchanged, each agent is typically responsible for providing access to a local Management Information Base (“MIB”) of objects that reflects the resources and activity at its managed device. The agent also responds to NMS requests to retrieve values from the local MIB and to set values in the local MIB. Each local MIB is a subset of the managed network MIB maintained at the NMS which relates to the managed objects for each managed device. One example of an object that can be retrieved is a counter that keeps track of the number of packets sent and received over a link into the device; the network manager can then track this value to monitor the load at that point in the network. One example of an object that can be set is one that represents the state of a link. In this example, the manager may disable the link by setting the value of the corresponding object to a “disabled” state.

Essentially, each local MIB is a set of named items that an SNMP agent understands. An additional feature of SNMP relates to asynchronous relay of information not specifically requested by the NMS. Upon occurrence of a significant network event, (e.g., device crash, reboot, excessive congestion, etc.) the event is defined in a local MIB module. When an agent notices that a significant event has occurred, it immediately reports the event to all management stations in its configuration list. This report is called a trap.

Conventional implementations of SNMP require that each device supporting SNMP (virtually all known network devices support SNMP management) include a listing of the various managed objects associated with the device. The identified managed objects are then compiled into the local MIB by the SNMP agent. Unfortunately, the identification and listing of these managed objects is not generally of primary concern to the device developers. Consequently, the creating and coding of this listing is often delayed until late into the development process and often, erroneous or incomplete listings accompany the final device. These errors can then disrupt or prevent efficient SNMP management of the device. Therefore, there is a need in the art of SNMP management systems for a system and method for ensuring the complete and accurate listing of managed objects.

Further, in responding to a get or set request, the agent examines its local MIB for the requested variables and, if found, provides them to the NMS. The local MIB is, in turn, populated based upon variables provided by the managed device. However, in some instances, all requested variables are not supported by the managed device, or are otherwise irretrievable by the agent. Unfortunately, some SNMP agents do not respond to partially populated MIB tables and may return no information, when in fact most of the requested information is available. In some circumstances, provision of partial information may even result in agent non-responsiveness, crash, or lockup of the entire system. Consequently, the get request by the NMS fails and a possibly erroneous error condition may be indicated. Therefore, there also remains a need in the art of SNMP managed networks for a system and method for supporting partial MIB population.

### SUMMARY OF THE INVENTION

The present invention overcomes the problems noted above, and provides additional advantages, by providing a system and method for accurately providing a uniform managed object listing in each managed device of a given class. In particular, each managed device of a specific type is grouped into a particular device class. A set of variables necessary to populate a local MIB for that device class are then defined as class attributes for the identified device class. The class attributes are then incorporated into the device driver for each individual device within the class. Because the device has been identified as a member of the class, when the agent requests the information for the local MIB, the class attributes are then called, resulting in the return of the requested information.

The present invention also overcomes the deficiencies noted above by providing a system and method for supporting partial MIB population in managed devices. A default, working copy of all local MIB information is stored within the agent as default MIB values. Upon request by the agent for MIB information from the device, the default MIB values are only overridden when corresponding values are returned from the device. Consequently, all local MIBs will always be fully populated.

### BRIEF DESCRIPTION OF THE DRAWINGS

FIG. 1 is a generalized block diagram illustrating an SNMP management system in accordance with the present invention.

FIG. 2 is a block diagram illustrating one embodiment of a system for populating a MIB.

FIG. 3 is a block diagram illustrating one embodiment of a system for supporting partial MIB population.

### DETAILED DESCRIPTION OF THE PREFERRED EMBODIMENTS

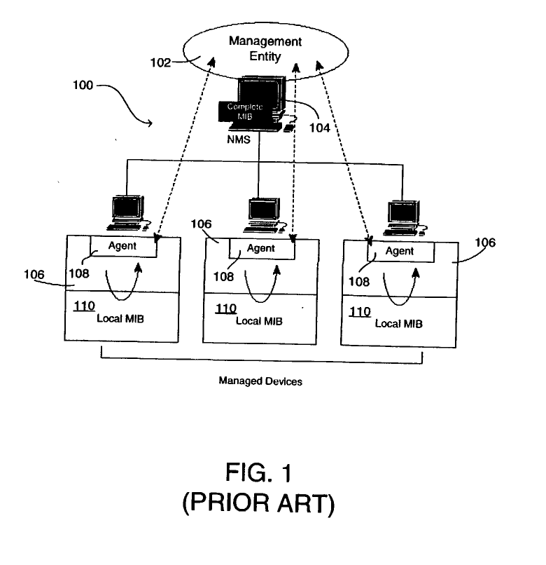

Referring generally to the figures and, in particular, to FIG. 1, there is shown a generalized block diagram schematically illustrating an SNMP management system 100 in accordance with one embodiment of the present invention. In particular, the SNMP management system 100 includes a management entity 102 such as the network operator or service provider. Associated with the management entity 102 is a Network Management System (NMS) 104 which interfaces via SNMP with the various managed devices 106. Each managed device 106 includes a resident SNMP agent 108 which, as described above, interfaces with the managed device to retrieve or modify device variables as requested by the NMS. Each agent 108 maintains a local Management Information Base (MIB) 110 relating to the managed variables for the device on which it is resident. The agent 108 interacts with the managed device 106 to populate the local MIB 110 and relay any requested MIB information to the NMS 104.

As set forth briefly above, prior to the SNMP agent's being able to populate its local MIB 110, each managed device 106 must be configured to include a set of defined variables for which it is responsible. In accordance with the present invention, managed devices 106 are categorized into various classes, where each class of device is responsible for the same types of MIB information. As will be set forth in additional detail below, the device driver for each device of a given class is then configured to include a class definition. The class definition consists of the various class attributes and attribute accessor methods (i.e., manners for retrieving the attribute values). In populating the local MIB 110, the agent 108 requests the values from the device 106, which, in accordance with the device driver, calls the established class methods and returns the requested values.

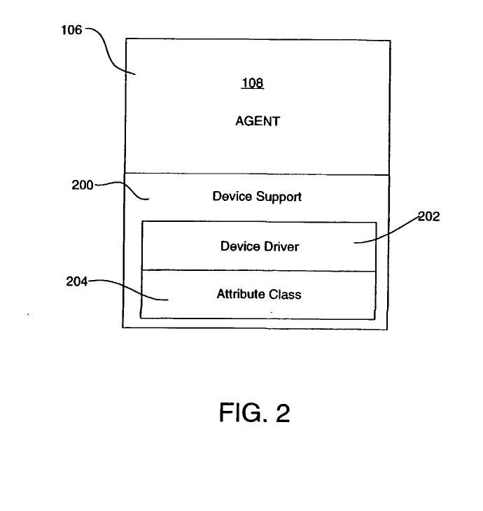

Referring now to FIG. 2, there is shown one embodiment of a managed device 106 having the features briefly described above. In particular, each managed device 106 includes an Agent 108 and a device support section 200. The device support section 200 includes a device driver 202 which, in accordance with the present invention, includes an attribute class definition 204 for the class to which the device belongs. The class definition 204 defines the various attributes necessary for MIB population and, when queried, enables the device to return values for the defined attributes. Providing for the definition of MIB required attributes in the inventive manner enables device developers to quickly and easily meet SNMP requirements. Further, the uniformity of the definitions across an entire class of devices significantly reduces the likelihood of providing missing or erroneous attributes to the MIB.

In one preferred embodiment, the present invention may be implemented in the form of source macros defining the Class context variables, attributes, and accessor methods. Class membership is then obtained by using the macros. Exemplary embodiments of several macros are illustrated below.

[image]

[image]

[image]

[image]

[image]

As described briefly above, due to various conditions, managed devices may not support all variables required by an SNMP agent in populating its local MIB. In such circumstances, the back-end MIB compiler would fail to include such values within the MIB. Consequently, since all required information is not present, the SNMP agent would identify the local MIB as a bad MIB and indicate such identification to the NMS resulting in an erroneous error condition being identified. In accordance with the present invention, such an occurrence is prevented.

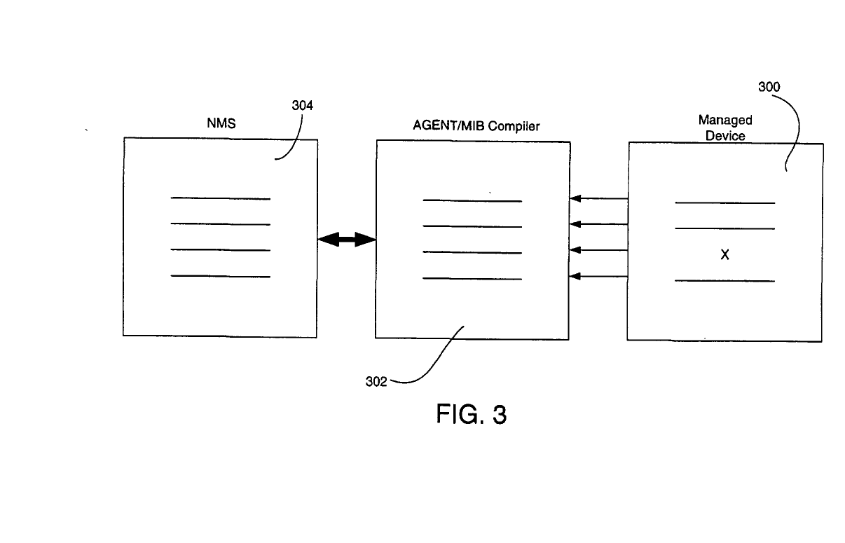

Referring now to FIG. 3, there is shown a block diagram illustrating one embodiment of a system for supporting partial MIB population in accordance with the present invention. The invention provides a method for partial table support (a table may be partially implemented intentionally, from the MIB back-end, or unintentionally with respect to the back-end designer, when the information provider (which may be beyond the control of the back-end designer) fails to implement a variable or method corresponding to a MIB object. Contrary to the conventional approach, the Agent/back-end MIB compiler 302 statically allocates a default device information table of the types to be partially supported. This becomes the default values for the management information base table, for those attributes permitted to not be included or supported by the managed device. In response to a SNMP Get request from the agent, the MIB table is populated with information from the device, if available. However, if information is not available for a particular object, that entry in the table is set to an appropriate value from the statically allocated default device information table of the types to be partially supported. This results in a fully populated MIB table, even where all objects were not retrieved from the device. The fully populated MIB table is then forward to the NMS 304. When the Agent is done handling the get request, a pointer is returned to the statically allocated table.

Essentially, by setting defaults for particular non-essential objects, the failure of the device to return values for these objects will not result in an agent malfunction, crash, or erroneous transmission to the NMS.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A system for populating management information base tables in a simple network management protocol system, comprising:
a managed device;
a network management system operatively connected to the managed device over a computer network;
a simple network management protocol agent residing on the managed device for collecting and storing device management information and relaying the information to the network management system upon request;
wherein the simple network management protocol agent initially maintains a table including device information to be partially supported in a management information base table, the table including working, default device information values, and
wherein, upon receipt of a get request from the network management system, the simple network management protocol agent populates the management information base table from both information provided by the managed device and the table including device information to be partially supported in a management information base table.

2. The system of claim 1, wherein the simple network management protocol agent includes a back-end management information base compiler.

3. The system of claim 2, wherein the back-end management information base compiler statically allocates the table including device information to be partially supported in the management information base table.

4. The system of claim 1, wherein the managed device provides only partial support for the management information base.

5. The system of claim 1, wherein the network management system and the simple network management protocol agent communicate via user datagram protocol over the computer network.

6. A method for populating management information base tables in a simple network management protocol system, comprising the steps of:
maintaining, at a managed device, a default device information table including device information to be partially supported in a management information base table, the default device information table including working, default device information values for objects that may not be supported by the managed device;
receiving, at a simple network management protocol agent resident on the managed device, a Get request from a network management system operatively connected to the managed device over a computer network;
determining whether all information to be included in the management information base table is available from the managed device;
populating the management information base table from both information provided by the managed device and the default device information table if it is determined that all information to be included in the management information base table is not available from the managed device; and
forwarding the fully populated management information base table to the network management system over the computer network.

7. The method of claim 6, wherein the simple network management protocol agent includes a back-end management information base compiler.

8. The method of claim 7, further comprising the step of statically allocating the default device information table by the back-end management information base compiler.

9. The method of claim 6, wherein the managed device provides only partial support for the management information base.

10. The method of claim 6, wherein the network management system and the simple network management protocol agent communicate via user datagram protocol over the computer network.

11. A computer-readable medium incorporating instructions for populating management information base tables in a simple network management protocol system, comprising:
one or more instructions for maintaining, at a managed device, a default device information table including device information to be partially supported in a management information base table, the default device information table including working, default device information values for objects that may not be supported by the managed device;
one or more instructions for receiving, at a simple network management protocol agent resident on the managed device, a Get request from a network management system operatively connected to the managed device over a computer network;
one or more instructions for determining whether all information to be included in the management information base table is available from the managed device;
one or more instructions for populating the management information base table from both information provided by the managed device and the default device information table if it is determined that all information to be included in the management information base table is not available from the managed device; and
one or more instructions for forwarding the fully populated management information base table to the network management system over the computer network.

12. The computer-readable medium of claim 11, wherein the simple network management protocol agent includes a back-end management information base compiler.

13. The computer-readable medium of claim 12, further comprising one or more instructions for statically allocating the default device information table by the back-end management information base compiler.

14. The computer-readable medium of claim 11, wherein the managed device provides only partial support for the management information base.

15. The computer-readable medium of claim 11, wherein the network management system and the simple network management protocol agent communicate via user datagram protocol over the computer network.
